(19) United States
(12) Patent Application Publication
(10) Pub. No.: US 2005/0080844 A1
(43) Pub. Date: Apr. 14, 2005

(54) System and method for managing scan destination profiles

(76) Inventors: Sridhar Dathathraya, Cerritos, CA (US); Michael Constantin, Irvine, CA (US)

Correspondence Address: Gerald W. Maliszewski, P.O. Box 270829, San Diego, CA, 92198-2829, US

(21) Appl. No.: 10/683,131

(22) Filed: Oct. 10, 2003

(51) Int. Cl. G06F 15/16

(52) U.S. Cl. 709/201

(57) ABSTRACT

A system and method are provided for an imaging device to manage scan destination profiles in a network of connected devices. The method comprises: accepting a profile at an imaging device. The profile may contain a network-connected destination, protocol instructions, and/or instructions to be performed at the destination. The method: temporarily stores the accepted profile; performs a scanning job; and, sends the scanned job to the profile destination. The profiles can be accepted from a storage device source such as a wireless telephone, PDA, or a smart card. In another aspect of the method, accepting a profile includes: establishing a wireless communication link between a proximity badge and a badge detector connected to the imaging device; identifying a user associated with the detected badge; accessing a network-connected server memory with profiles cross-referenced to user identities; and, downloading a profile from the server associated with the identified user.

### BACKGROUND OF THE INVENTION

1. Field of the Invention

This invention generally relates to digital document processing and, more particularly, to a system and method for managing the profiles associated with sending scanned documents to a network-connected destination.

2. Description of the Related Art

A multifunction peripheral (MFP) devices, scanner, digital copier, fax machine, or the like, which shall be referred to herein imaging devices or digital imaging devices, typically permit a user to scan a document, and send the scanned output to remote location called a scan destination. The imaging device may also change the format of the scanned job before it is sent. The list of destinations is typically stored in an imaging device memory. When a user wants to use the imaging device to scan and send the scanned output to a destination, such as an email address or to a desktop personal computer (PC), the user must select a scan destination from the list of available scan destinations displayed on imaging device front panel. If the imaging device has a large number of destinations, then the selection process can take considerable amount of time, as the user must select different menu options, and/or scroll through a list of possible destinations.

Furthermore, this method of selecting scan destinations requires that the destinations be created prior to, or simultaneously with the job to be scanned on the imaging device. Creating a destination requires the user, or a systems administrator, to find a computer connected to the network, locate the imaging device in the network, create a destination, and store the destination in the imaging device memory.

This method of storing the scan destinations on the imaging device requires a lot of management, as an administrator must periodically check for invalid destinations and purge them from memory. For example, destinations associated with former employees may become invalid. This method of storing profiles also restricts the usefulness of the imaging devices. For example, a commercial copy shop, such as Kinko, may have copiers with the capability of storing destination profiles, but it is currently impractical for a user or the copy shop management to create a list destination profiles for an irregular or first-time customer.

It would be advantageous if a user could easily add a profile for use with an imaging device, to create a destination for a scanned document.

It would be advantageous if an imaging device could use destination profiles, without maintaining a burdensome list of profiles in permanent memory.

### SUMMARY OF THE INVENTION

The objective of this invention is to make it easy for users to select scan destinations for scanning jobs performed on a copier or imaging device. This invention eliminates the need for storing the scan destination information on the imaging device itself. The present invention uses storage space available in source devices such as cell phones, personal digital assistants (PDAs), or smart cards, to name a few examples, to store the scan destinations for the user.

A typical user is likely to have 2 to 3 possible destinations to which they might send a scanned document. The space available on the above-mentioned source devices is more than adequate for this purpose. The imaging devices then require an interface for transferring the scan destinations from these source devices. For example, a modem can be used to interface to a phone source device, an infrared port can interface to a PDA, and a smart card reader can interface with a smart card. After the imaging device obtains the list of scan destination from the user's source device, they are displayed on the LCD front panel. The user can then select the destination from the panel for the copy operation.

Accordingly, a method is provided for an imaging device to manage scan destination profiles in a network of connected devices. The method comprises: accepting a profile at a network-connected imaging device. The profile may contain a network-connected destination, the protocol to be used in transmission to the destination, and/or instructions to be performed at the destination. The method: temporarily stores the accepted profile; performs a scanning job; and, sends the scanned job to the profile destination.

As mentioned above, the profiles can be accepted from a storage device source such as a wireless telephone, PDA, or a smart card. In another aspect of the method, accepting a profile includes: establishing a wireless communication link between a proximity badge and a badge detector connected to the imaging device; identifying a user associated with the detected badge; accessing a network-connected server memory with profiles cross-referenced to user identities; and, downloading a profile from the server associated with the identified user.

Typically, a user will have more than one destination in the profile. In that case, an imaging device user interface (UI) or front panel displays the profile. A destination is selected from the displayed profile, and the scanned job is sent to the selected destination. In other aspect, the method further comprises erasing the temporarily stored profile, after the scanned job is sent.

Additional details of the above-described method, and a system used by an imaging device for managing scan destination profiles in a network of connected devices, are provided below.

### BRIEF DESCRIPTION OF THE DRAWINGS

FIG. 1 is a schematic block diagram of the present invention system, used by an imaging device, for managing scan destination profiles in a network of connected devices.

FIG. 2 is a drawing depicting an exemplary profile.

FIG. 3 is a schematic diagram depicting a first aspect of the invention of FIG. 1.

FIG. 4 is a schematic block diagram depicting a second aspect of the invention of FIG. 1.

FIG. 5 is a schematic block diagram depicting a third aspect of the invention of FIG. 1.

FIG. 6 is a schematic block diagram depicting a fourth aspect of the invention of FIG. 1.

FIGS. 7a and 7b are flowcharts illustrating the present invention method used by an imaging device for managing scan destination profiles in a network of connected devices.

### DETAILED DESCRIPTION OF THE PREFERRED EMBODIMENTS

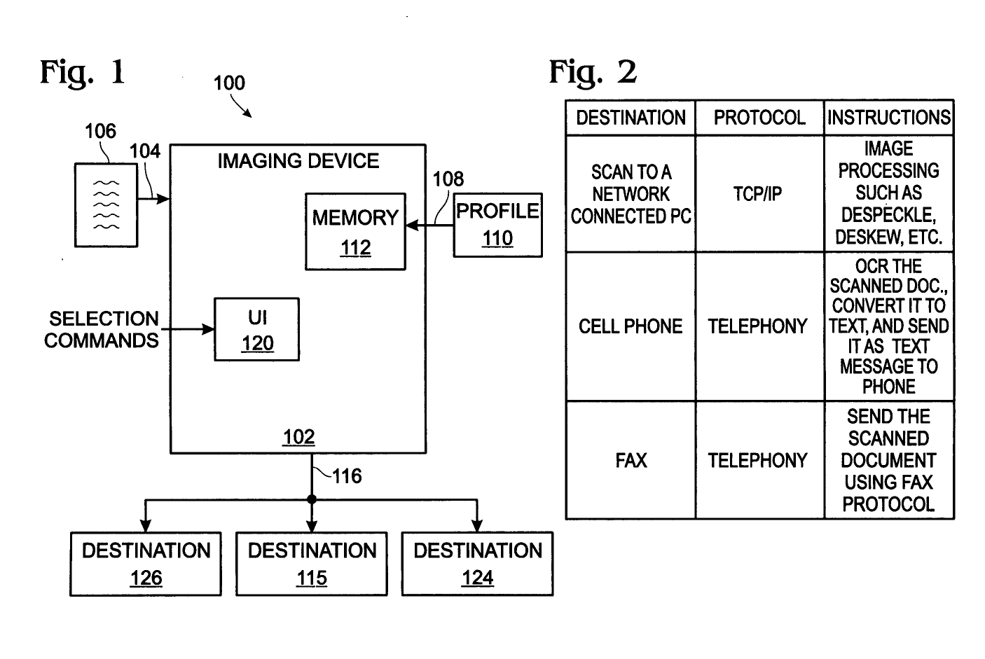

FIG. 1 is a schematic block diagram of the present invention system, used by an imaging device, for managing scan destination profiles in a network of connected devices. The system 100 comprises a network-connected imaging device 102. The imaging device 102 includes a job interface on line 104 to accept a job to be scanned. The job to be scanned is represented by reference designator 106. For example, a hardcopy or paper document can be accepted. In other aspects, an electronic copy of a document or image can be accepted, perhaps for additional digital processing steps.

A profile interface on line 108 accepts a profile including a network-connected destination. The profile is represented by reference designator 110. The imaging device 102 further includes a memory 112 for temporarily storing the accepted profile, and a transmission interface on line 114 for sending the scanned job to the profile destination 115 via network 116. The invention is not limited to any particular type of network 116. The network 116 can be an Internet, Intranet, or local area network (LAN) to name a few examples. The destination 115 may be a server or a PC, for example. In some aspects, the memory 112 is a type of random access memory (RAM).

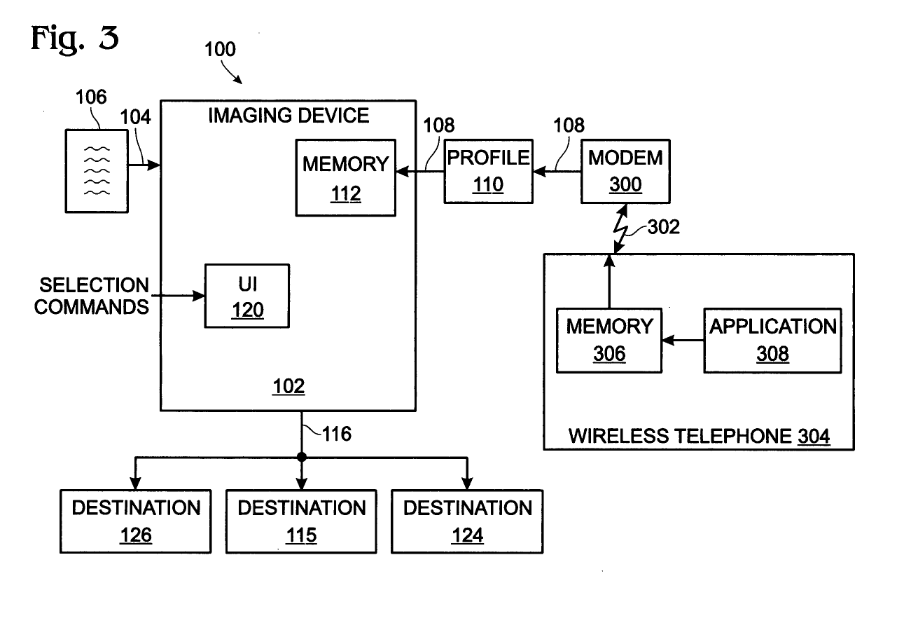

FIG. 2 is a drawing depicting an exemplary profile. The profile shown has three different destinations. In addition, the profile includes additional information or fields associated with each destination. Shown is a field for the protocol to be used in sending the scanned job and a field for instructions to be performed at the destination upon receipt of the scanned job. The present invention is not limited to any particular number of destinations, any particular number of auxiliary fields associated with the destination, or any particular auxiliary field types.

Returning to FIG. 1, typically the profile interface on line 108 accepts a profile with a plurality of network-connected destination. If so, the plurality of possible destinations may be displayed on an imaging device user interface (UI) 120. The UI 120 then accepts a destination selected from the displayed profile, as represented by reference designator 122, and the transmission interface on line 114 sends the scanned job to the destination selected at the UI 120. The possible alternate destinations are represented by reference designators 124 and 126. In other aspects, the imaging device 102 erases the temporarily stored profile from memory 112, after the scanned job is sent.

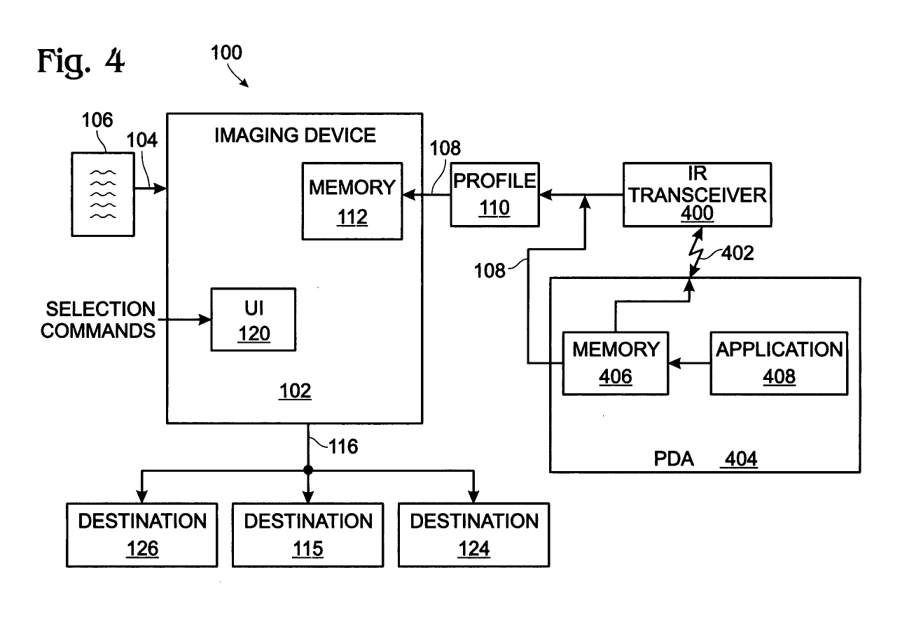

FIG. 3 is a schematic diagram depicting a first aspect of the invention of FIG. 1. Some aspects of the system 100 further comprise a wireless modem 300 having a wireless telephone interface represented by reference designator 302 and a hardwire interface connected to the imaging device profile interface on line 108. The wireless modem 300 establishes a wireless telephone communication link for downloading the profile, and relaying the profile to the imaging device 102.

A wireless telephone 304 has a memory 306 for storing the profile, an application 308 for loading and transferring the profile, and a wireless transceiver 310 for transmitting the profile via interface 302.

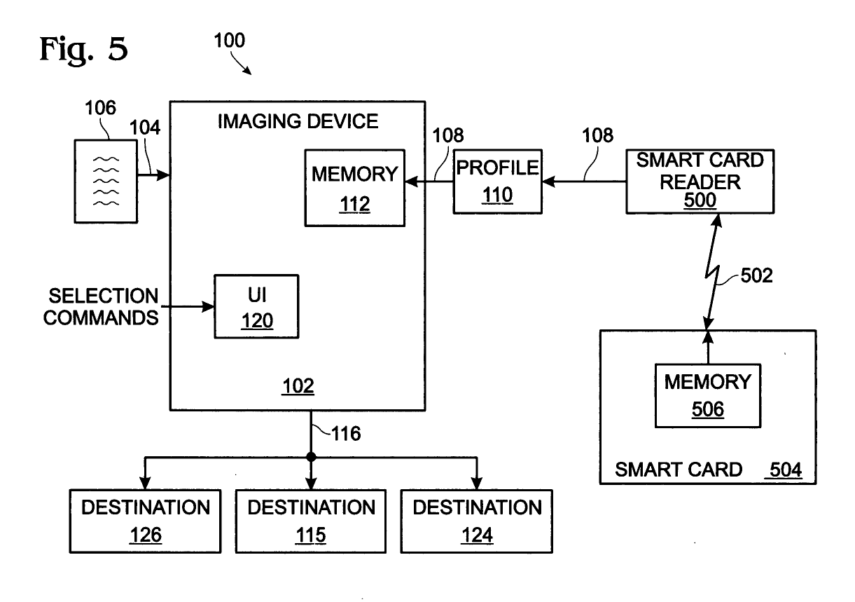

FIG. 4 is a schematic block diagram depicting a second aspect of the invention of FIG. 1. An infrared (IR) transceiver 400 has an infrared interface represented by reference designator 402 and a hardwire interface link to the imaging device profile interface on line 108. The IR transceiver 400 establishes an IR communications link for downloading the profile and relaying it to the imaging device 102. A PDA 404 has a memory 406 for storing the profile, an application 408 for loading and transferring the profile, and an IR transceiver 410 for transmitting the profile via interface 402.

In other aspects, the PDA 404 has a local connection interface, such as USB, serial, or parallel port connection to the imaging device profile interface on line 108. As above, the PDA 404 has a memory 406 to store the profile and an application 408 for loading and transferring the profile.

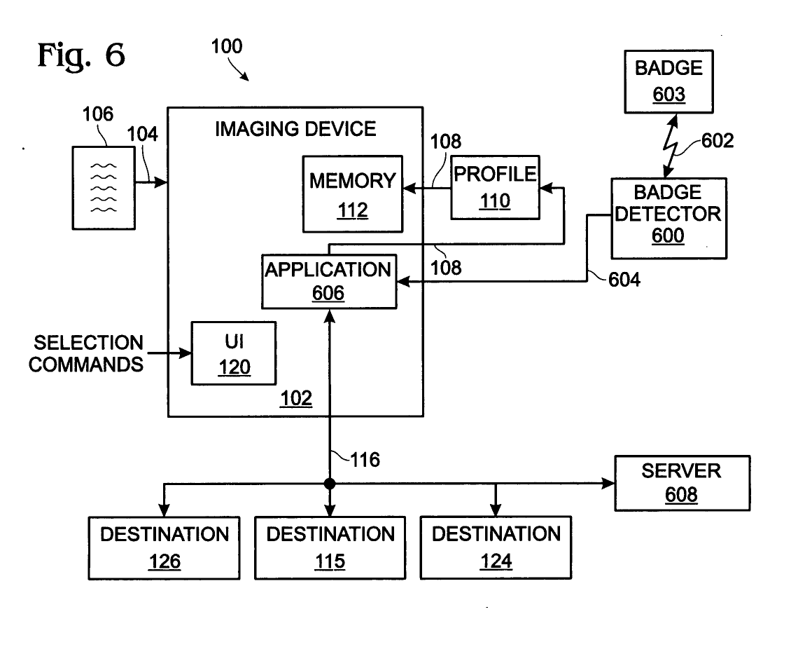

FIG. 5 is a schematic block diagram depicting a third aspect of the invention of FIG. 1. The system 100 further comprises a smart card reader 500 having a wireless interface represented by reference designator 502 and an interface locally connected to the imaging device profile interface on line 108. The smart card reader 500 establishes a wireless communication link 502 to download the profile and relay it to the imaging device 102. A smart card 504 has a memory 506 to store the profile and a wireless interface 508 for transmitting the profile. The application for managing the profile transfer, not shown, can either be embedded with the smart card reader 500 or the smart card 504 itself.

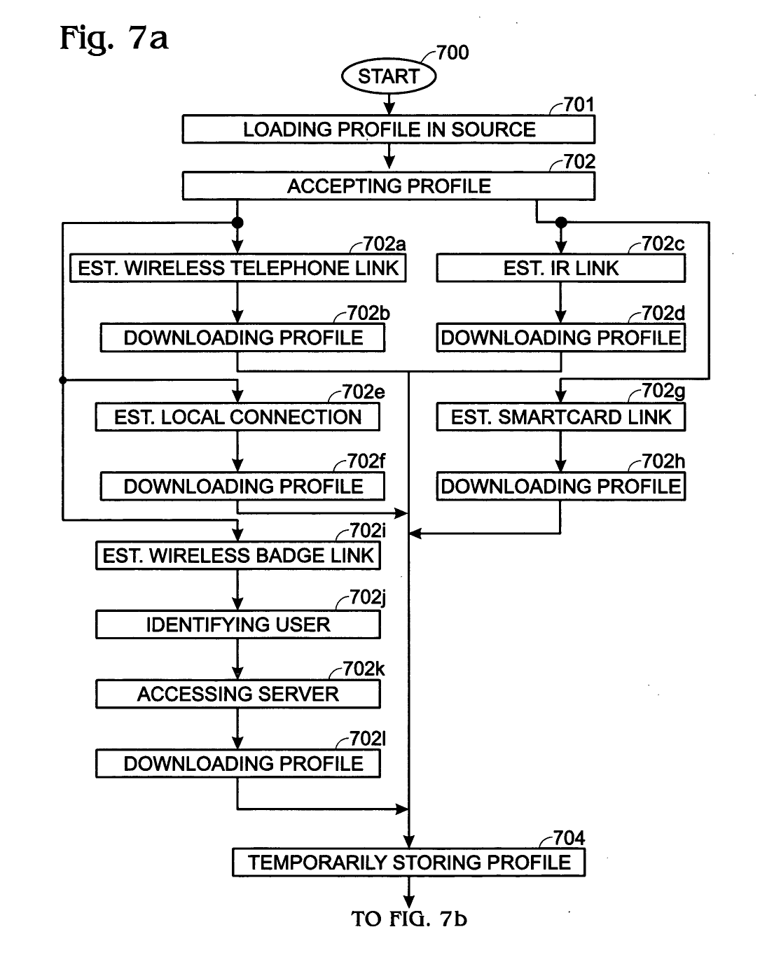

FIG. 6 is a schematic block diagram depicting a fourth aspect of the invention of FIG. 1. The system 100 further comprises a proximity badge detector 600 having a wireless interface represented by reference designator 602. The badge detector 600 establishes a wireless communication link to download and relay a user identity associated with badge 603. The badge detector 600 has an interface on line 604 to supply the user identity. The imaging device 102 further includes an application 606 to accept the user identity on line 604 from the badge detector 600 and to launch a user destination query via a network interface on line 116. A network-connected server 608 has a memory 610 with profiles cross-referenced to user identities. The server 608 sends a profile to the imaging device application 606 in response to receiving the user destination query. The application 606 also has an interface on line 108 connected to the profile interface to relay the profile received from the server 608.

### Functional Description

In addition to downloading profile information to the imaging device, a user must also create and load the scan destination in the storage device source. This can be accomplished in a number of ways. For example, custom designed software can be designed using the SharpDesk NST running on a personal computer, that permits a user to enter the scan destination information and transfer it to the storage device source.

The imaging device negotiates with the source device, and the scan destinations stored in the source devices are displayed as a list on the imaging device's front panel. Different types of communication protocols can be used by the imaging device for negotiating with the storage device source. For example, if a PDA is used for storing the scan destinations, the imaging device might use an infrared port for communicating with the PDA. If a cell phone is used as the source, the user can dial the imaging device's modem and send the scan destination stored in the phone to the imaging device.

The following is an exemplary set of steps that my be performed to enable the invention:
1. A user walks to the imaging device with the documents to scan.
2. The imaging device communicates with the user's storage device source and obtains the list of scan destinations.
3. The imaging device displays this list on the imaging device front panel.
4. The user selects the destination from the list.
5. The user places the documents to be scanned in the imaging device.
6. The user starts the scan process.
7. The imaging device performs the scan process and sends the scanned document to the selected destination(s).

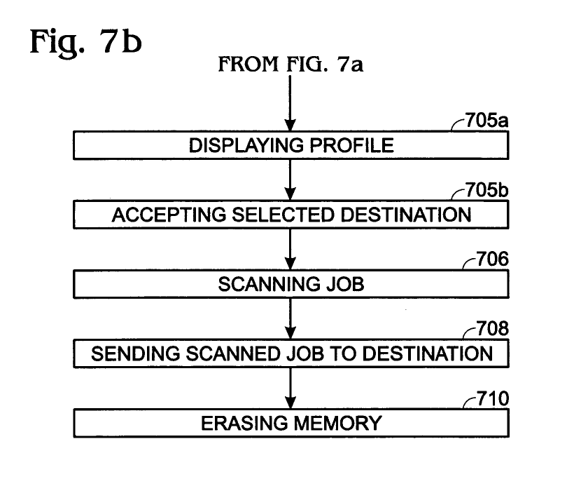

FIGS. 7a and 7b are flowcharts illustrating the present invention method used by an imaging device for managing scan destination profiles in a network of connected devices. Although the method is depicted as a sequence of numbered steps for clarity, no order should be inferred from the numbering unless explicitly stated. It should be understood that some of these steps may be skipped, performed in parallel, or performed without the requirement of maintaining a strict order of sequence. The method starts at Step 700.

Step 701 loads a profile in a storage device source. Step 702 accepts a profile including a network-connected destination. Step 704 temporarily stores the accepted profile at a network-connected imaging device. Step 706 performs a scanning job. Step 708 sends the scanned job to the profile destination. Step 710, following the sending of the scanned job, erases the temporarily stored profile.

Accepting a profile including a network-connected destination in Step 702 includes accepting a profile from a storage device source selected from the group including a wireless telephone, a personal digital assistant (PDA), a smart card, and a network connected server. This is not intended to be an exhaustive list of every possible source. In other aspects, Step 702 accepts a profile additionally with information such as the protocol to be used in sending the scanned job and/or instructions to be performed at the destination upon receipt of the scanned job. Other types of profile fields are also possible.

In some aspect, Step 702 includes substeps. Step 702a establishes (est.) a wireless telephone communication link between a wireless telephone and a modem locally connected to the imaging device. Step 702b downloads the profile from a memory in the wireless phone, through the modem, to the imaging device.

In another aspect, Step 702c establishes an infrared communication link between a PDA and an infrared transceiver connected to the imaging device. Step 702d downloads the profile from a memory in the PDA, through the infrared transceiver, to the imaging device.

In another aspect, Step 702e establishes a local connection between a PDA and the imaging device, such as USB, serial, or parallel port connection. Note, the invention is not limited to any particular type of local connection. Step 702f downloads the profile from a memory in the PDA to the imaging device.

In some aspects, Step 702g establishes a communication link between a smart card and a smart card reader connected to the imaging device. Step 702h downloads the profile from a memory in the smart card, through the reader, to the imaging device.

In another aspect, Step 702i establishes a wireless communication link between a proximity badge and a badge detector connected to the imaging device. Step 702j identifies a user associated with the detected badge. Step 702k accesses a network-connected server memory with profiles cross-referenced to user identities. Step 702l downloads a profile from the server associated with the identified user.

In other aspects, accepting a profile including a network-connected destination in Step 702 includes accepting a plurality of destinations in the profile. Then, the method may comprise additional steps. Step 705a displays the profile at a user interface (UI). Step 705b accepts a destination selected from the displayed profile. Then, sending the scanned job to the destination from the profile in Step 708 includes sending the job to the selected destination.

A system and method have been provided managing destination profiles in an imaging device, which does not require the permanent storage of profiles for every device user. A few examples have been given of storage device sources, but the invention is not limited to merely these examples. Examples have also been given of auxiliary profile fields. Again the invention is not limited to just the examples. In other embodiments of the invention, a user can select from the auxiliary fields embedded in the profile, as well as the destinations. Although the invention has been described in the context of an imaging device, it has application to a broader class of devices. Other variations and embodiments of thee invention will occur to those skilled in the art.

1. In a network of connected devices, a method used by an imaging device for managing scan destination profiles, the method comprising:
at a network-connected imaging device, accepting a profile including a network-connected destination;
temporarily storing the accepted profile;
performing a scanning job; and,
sending the scanned job to the profile destination.

2. The method of claim 1 wherein accepting a profile including a network-connected destination includes accepting a profile from a storage device source selected from the group including a wireless telephone, a personal digital assistant (PDA), a smart card, and a network connected server.

3. The method of claim 2 wherein accepting a profile includes:
establishing a wireless telephone communication link between a wireless telephone and a modem locally connected to the imaging device;
downloading the profile from a memory in the wireless phone, through the modem, to the imaging device.

4. The method of claim 2 wherein accepting a profile includes:
establishing an infrared communication link between a PDA and an infrared transceiver connected to the imaging device; and,
downloading the profile from a memory in the PDA, through the infrared transceiver, to the imaging device.

5. The method of claim 2 wherein accepting a profile includes:
establishing an local connection between a PDA and the imaging device selected from the group including USB, serial, and parallel port connections; and,
downloading the profile from a memory in the PDA to the imaging device.

6. The method of claim 2 wherein accepting a profile includes:
establishing a communication link between a smart card and a smart card reader connected to the imaging device;
downloading the profile from a memory in the smart card, through the reader, to the imaging device.

7. The method of claim 2 wherein accepting a profile includes:
establishing a wireless communication link between a proximity badge and a badge detector connected to the imaging device;
identifying a user associated with the detected badge;
accessing a network-connected server memory with profiles cross-referenced to user identities; and,
downloading a profile from the server associated with the identified user.

8. The method of claim 1 wherein accepting a profile including a network-connected destination includes accepting a plurality of destinations in the profile.

9. The method of claim 8 further comprising:
at a user interface (UI), displaying the profile;
accepting a destination selected from the displayed profile; and,
wherein sending the scanned job to the destination from the profile includes sending the job to the selected destination.

10. The method of claim 2 further comprising:
loading the profile in the storage device source.

11. The method of claim 1 further comprising:
following the sending of the scanned job, erasing the temporarily stored profile.

12. The method of claim 1 wherein accepting a profile includes accepting a profile additionally with information selected from the group including the protocol to be used in sending the scanned job and instructions to be performed at the destination upon receipt of the scanned job.

13. In a network of connected devices, an imaging device system for managing scan destination profiles, the system comprising:
a network-connected imaging device including:
a job interface to accept a job to be scanned;
a profile interface to accept a profile including a network-connected destination;
a memory for temporarily storing the accepted profile; and,
a transmission interface for sending the scanned job to the profile destination.

14. The system of claim 13 further comprising:
a wireless modem having a wireless telephone interface and a hardwire interface connected to the imaging device profile interface, the wireless modem establishing a wireless telephone communication link for downloading the profile, and relaying the profile to the imaging device.

15. The system of claim 14 further comprising:
a wireless telephone with a memory for storing the profile, an application for loading and transferring the profile, and a wireless transceiver for transmitting the profile.

16. The system of claim 14 further comprising:
an infrared (IR) transceiver having an infrared interface and a hardwire interface link to the imaging device profile interface, the IR transceiver establishing an IR communications link for downloading the profile and relaying it to the imaging device.

17. The system of claim 16 further comprising:
a personal digital assistant (PDA) having a memory for storing the profile, an application for loading and transferring the profile, and an IR transceiver for transmitting the profile.

18. The system of claim 14 further comprising:
a PDA having a local connection interface selected from the group including USB, serial, and parallel ports, connected to the imaging device profile interface, the PDA having a memory to store the profile and an application for loading and transferring the profile.

19. The system of claim 14 further comprising:
a smart card reader having an wireless interface and an interface locally connected to the imaging device profile interface, the smart card reader establishing a wireless communication link to download the profile and relay it to the imaging device.

20. The system of claim 19 further comprising:
a smart card having a memory to store the profile and a wireless interface for transmitting the profile.

21. The system of claim 14 further comprising:
a proximity badge detector having a wireless interface and an interface connected to the imaging device profile interface, the badge detector establishing a wireless communication link to download and relay a user identity;
wherein the imaging device further includes:
an application to accept the user identity from the badge detector and a network interface to launch a user destination query;
the system further comprising:
a network-connected server including a network interface and a memory with profiles cross-referenced to user identities, the server sending a profile to the imaging device application in response to receiving the user destination query; and,
wherein the imaging device application has an interface connected to the profile interface to relay the profile received from the server.

22. The system of claim 13 wherein the profile interface accepts a profile including a plurality of network-connected destination.

23. The system of claim 22 wherein the imaging device further includes:
a user interface (UI) for displaying the plurality of destinations in the profile and for accepting a destination selected from the displayed profile; and,
wherein the transmission interface sends the scanned job to the destination selected at the UI.

24. The system of claim 13 wherein the imaging device erases the temporarily stored profile from memory, after the scanned job is sent.

25. The system of claim 13 wherein the imaging device profile interface accepts a profile additionally including information selected from the group including the protocol to be used in sending the scanned job and instructions to be performed at the destination upon receipt of the scanned job.
